(19) United States
(12) Patent Application Publication
(10) Pub. No.: US 2026/0321518 A1
(43) Pub. Date: Oct. 15, 2026

(54) ELECTROLYTIC CAPACITOR

(71) Applicant: Panasonic Intellectual Property Management Co., Ltd., Osaka (JP)

(72) Inventors: Hiroyuki ARIMA, OSAKA FU (JP); Akito NAKAMURA, AICHI KEN (JP)

(21) Appl. No.: 18/880,740

(22) PCT Filed: Jul. 6, 2023
(86) PCT No.: PCT/JP2023/025111

§ 371 Date: Jan. 2, 2025

(30) Foreign Application Priority Data
Jul. 6, 2022 (JP) 2022-109139

(51) Int. Cl. H01G 9/035

(52) U.S. Cl. CPC H01G 9/035; H01G 9/145

(57) ABSTRACT

An electrolytic capacitor includes a capacitor element and a liquid component. The capacitor element includes an anode body having a dielectric layer on a surface thereof and a conductive polymer covering at least a portion of the dielectric layer. The liquid component includes an acid component and a solvent. The acid component includes a first carboxylic acid compound that has a plurality of first moieties. The plurality of first moieties each independently have a first carboxy group including a first carbonyl group, a second carbonyl group, and a first linking group linking the first carbonyl group and the second carbonyl group.

### TECHNICAL FIELD

The present disclosure relates to an electrolytic capacitor.

### BACKGROUND ART

Electrolytic capacitors that include an anode body provided with a dielectric layer, a conductive polymer covering at least a portion of the dielectric layer, and an electrolytic solution are regarded as promising small, high-capacity, low-ESR (equivalent series resistance) capacitors. The conductive polymer includes a conjugated polymer and a dopant, for example. A liquid component such as a non-aqueous solvent or a solution obtained by dissolving a solute in a non-aqueous solvent is used as the electrolytic solution.

PTL 1 proposes a conductive polymer hybrid aluminum electrolytic capacitor including a capacitor element obtained by winding an anode foil having an aluminum dielectric oxide film formed thereon and a cathode foil with a separator interposed therebetween. The electrolytic capacitor includes a conductive polymer layer formed on the dielectric oxide film and an electrolytic solution, wherein the electrolytic solution includes a solute and a solvent, the solvent includes diethylene glycol and/or triethylene glycol, and the solute includes a salt of a long-chain dibasic carboxylic acid (dicarboxylic acid) having 12 or more carbon atoms and an amine having a boiling point of 150° C. or higher.

Electrolytic solutions containing a carboxylic acid, a salt of a carboxylic acid, or the like as described in PTL 2 to PTL 4 are also known as electrolytic solutions for electrolytic capacitors.

### CITATION LIST

### Patent Literature

PTL 1: Japanese Laid-Open Patent Publication No. 2021-64768
PTL 2: Japanese Laid-Open Patent Publication No. H01-103821
PTL 3: Japanese Laid-Open Patent Publication No. 2004-71727
PTL 4: Japanese Laid-Open Patent Publication No. 2019-102791

### SUMMARY OF INVENTION

### Technical Problem

The conductive polymer has a high conductivity in a state where a conjugated polymer is doped with a dopant, for example. If the liquid component includes an acid component, de-doping of the dopant is suppressed, and it is expected that the high conductivity of the conductive polymer can be maintained. However, even if a liquid component containing an acid component is used, there are actually cases where it is difficult to suppress a reduction in the conductivity of the conductive polymer over time when the electrolytic capacitor is used, and it is difficult to suppress an increase in the ESR.

### Solution to Problem

An aspect of the present disclosure relates to an electrolytic capacitor including a capacitor element and a liquid component,
wherein the capacitor element includes an anode body having a dielectric layer on a surface thereof and a conductive polymer covering at least a portion of the dielectric layer,
the liquid component includes an acid component and a solvent,
the acid component includes a first carboxylic acid compound that has a plurality of first moieties, and
the plurality of first moieties each independently have:
   a first carboxy group including a first carbonyl group;
   a second carbonyl group; and
   a first linking group linking the first carbonyl group and the second carbonyl group.

### Advantageous Effects of Invention

It is possible to suppress a change in the ESR over time in an electrolytic capacitor including a conductive polymer.

### BRIEF DESCRIPTION OF DRAWINGS

FIG. 1 is a schematic cross-sectional view of an electrolytic capacitor according to an embodiment of the present disclosure.

FIG. 2 is a schematic view of a capacitor element of the electrolytic capacitor shown in FIG. 1 with a portion thereof being developed.

### DESCRIPTION OF EMBODIMENTS

Novel features of the present invention are set forth in the appended claims, but the present invention, both in terms of structure and content, together with other objects and features of the present invention, will be better understood from the following detailed description taken in conjunction with the drawings.

If a liquid component containing an acid component is used in an electrolytic capacitor that includes a conductive polymer, it is expected that de-doping from the conductive polymer can be suppressed because the liquid component has a low pH, and a high conductivity of the conductive polymer can be maintained. However, even if a liquid component containing an acid component is used, there are actually cases where the high conductivity of the conductive polymer cannot be maintained. This is presumably because solubility of the acid component in a non-aqueous solvent is low or the acid component reacts with the non-aqueous solvent, for example, and therefore, the effect of suppressing the progress of de-doping cannot be sufficiently achieved and the conductive polymer deteriorates. If the deterioration of the conductive polymer progresses as the electrolytic capacitor is used, the conductivity of the conductive polymer decreases and the ESR increases.

In an electrolytic capacitor that does not include a conductive polymer but includes a liquid component, the ESR of the electrolytic capacitor is significantly affected by ion conductivity of the liquid component, the state of electrical connection between constituent elements of the electrolytic capacitor, and the like. In contrast, in an electrolytic capacitor that includes a conductive polymer but does not include a liquid component, the conductive polymer tends to have a higher resistance than a cathode extraction layer constituting a cathode body, an anode body, or the like. Therefore, the conductivity of the conductive polymer significantly affects the ESR as described above. In order to maintain the high conductivity, it is important to stabilize the conductive polymer because deterioration of the conductive polymer progresses as described above as the electrolytic capacitor is used. If the electrolytic capacitor includes the conductive polymer and a liquid component, the liquid component significantly affects the state (including the conductivity, stability, etc.) of the conductive polymer. However, the mechanism of a liquid component affecting the ESR of an electrolytic capacitor completely differs between an electrolytic capacitor that includes a conductive polymer and the liquid component and an electrolytic capacitor that does not include a conductive polymer but includes the liquid component, because there is no resistance of the conductive polymer and interaction between the conductive polymer and the liquid component in the latter electrolytic capacitor. Therefore, even if a liquid component used in an electrolytic capacitor that does not include a conductive polymer is applied to an electrolytic capacitor that includes a conductive polymer, it is unknown whether an effect of stabilizing the conductive polymer and suppressing the reduction in the conductivity can be achieved unconditionally, and it is also unknown whether an effect of suppressing the change in the ESR over time can be achieved.

In view of the above circumstances, (1) an electrolytic capacitor according to the present disclosure includes a capacitor element and a liquid component,
wherein the capacitor element includes an anode body having a dielectric layer on a surface thereof and a conductive polymer covering at least a portion of the dielectric layer,
the liquid component includes an acid component and a solvent,
the acid component includes a first carboxylic acid compound that has a plurality of first moieties, and
the plurality of first moieties each independently have:
   a first carboxy group including a first carbonyl group;
   a second carbonyl group; and
   a first linking group linking the first carbonyl group and the second carbonyl group.

The liquid component contains the acid component that includes the first carboxylic acid compound, and therefore, it is possible to suppress a change in the ESR over time (in other words, an increase in the ESR over time) when the electrolytic capacitor is used. It is thought that the change in the ESR over time is suppressed for the following reasons.

First, the second carbonyl group of the first carboxylic acid compound is easily coordinated to a cationic moiety of the conductive polymer due to charge bias, and therefore, the conductive polymer can be stabilized. Moreover, since the second carbonyl group is easily coordinated to the conductive polymer, the first carboxy group is likely to be close to the conductive polymer, and therefore, the conductive polymer can be stabilized. Owing to such stabilizing action of the plurality of second carbonyl groups and the plurality of first carboxy groups, the progress of de-doping from the conductive polymer is suppressed when the electrolytic capacitor is used, and accordingly, deterioration of the conductive polymer is suppressed and a high conductivity is maintained. It is thought that, therefore, the change in the ESR over time is suppressed.

Moreover, the first carboxylic acid compound is likely to form an appropriate film on the surface of the dielectric layer provided on the surface of the anode body. This film improves film repair properties of the dielectric layer, and accordingly, it is possible to suppress a leakage current even when the electrolytic capacitor is used for a long period of time. Also, it is possible to maintain the state where a large amount of the liquid component is held by the conductive polymer in the vicinity of the dielectric layer because deterioration of the conductive polymer over time is suppressed by the action of the first carboxylic acid compound. It is thought that the film repair properties of the dielectric layer are improved for this reason as well.

Additionally, the pH of the liquid component can be kept relatively low while a relatively high conductivity of the conductive polymer is secured. Accordingly, the dielectric layer is easily repaired, and therefore, it is also possible to secure a high degree of withstand voltage properties.

(2) In (1) above, the first carboxylic acid compound may include a second linking group, and the second linking group may link the second carbonyl groups of the plurality of first moieties. In this case, the action of the first carboxylic acid compound on the conductive polymer is enhanced and the conductive polymer is further stabilized, and therefore, the change in the ESR over time can be further suppressed. Also, it is easy to introduce the plurality of first moieties into the first carboxylic acid compound.

(3) In (2) above, the second linking group may have an oxygen atom or an amino group linked to each of the second carbonyl groups. In this case, it is possible to easily introduce the first moieties into the first carboxylic acid compound via the oxygen atom or the amino group.

(4) In any one of (1) to (3) above, in a molecule of the first carboxylic acid compound, the first linking groups of at least two of the first moieties may have the same structure. In this case, it is relatively easy to design the molecule of the first carboxylic acid compound and synthesize the first carboxylic acid compound. Also, the distance between the first carbonyl groups or the first carboxy groups is determined to some extent, and accordingly, it is thought that the action of the first carboxylic acid compound on the conductive polymer is enhanced.

(5) In any one of (1) to (4) above, in the first linking groups of at least two of the first moieties, a main chain linking a first carbon atom in the first carbonyl group and a second carbon atom in the second carbonyl group may have 1 to 4 carbon atoms. In this case, the distance between the first carboxy group and the second carbonyl group is relatively short, and accordingly, a stabilized structure is likely to be formed when the first carboxy group is ionized, and acidity is likely to be maintained around the conductive polymer.

(6) In any one of (1) to (5) above, the first linking groups of at least two of the first moieties may each include a non-aromatic cyclic divalent group or an aromatic divalent group. In this case, it is easy to adjust solubility of the first carboxylic acid compound in a solvent and affinity of the first carboxylic acid compound to the dielectric layer. Also, the first carboxy group is likely to be stabilized and the positions of the second carbonyl group and the first carboxy group are likely to be fixed, and therefore, the pH of the liquid component tends to be low.

(7) In any one of (1) to (5) above, in the first linking groups of at least two of the first moieties, a main chain linking a first carbon atom in the first carbonyl group and a second carbon atom in the second carbonyl group may be an aliphatic divalent group. In this case, it is possible to improve the function of the liquid component repairing the dielectric layer, and the effect of suppressing a leakage current is further enhanced.

(8) In (7) above, the aliphatic divalent group may have one or more first substituents, and the aliphatic divalent group may have a monovalent aliphatic hydrocarbon group having 6 or more carbon atoms as at least one of the one or more first substituents. In this case, an effect of suppressing esterification of the first carboxy group is enhanced, and a higher conductivity of the conductive polymer is likely to be secured. Additionally, the withstand voltage properties of the electrolytic capacitor can be further improved.

(9) In (8) above, the aliphatic divalent group may have the monovalent aliphatic hydrocarbon group at an α position of the first carbonyl group. The effect of suppressing esterification of the first carboxy group is further enhanced by the aliphatic hydrocarbon group that serves as a steric hindrance, and the effect of suppressing the change in the ESR can be enhanced.

(10) In any one of (1) to (9) above, the acid component may further include a second carboxylic acid compound that differs from the first carboxylic acid compound. In this case, it is easy to reduce the pH of the liquid component, and it is also possible to further suppress the change in the ESR over time while securing the withstand voltage properties to some extent due to the first carboxylic acid compound.

(11) In any one of (1) to (10) above, the first carboxylic acid compound may account for 20% by mass or more of the acid component. In this case, the effect of suppressing the change in the ESR over time is further enhanced. Also, it is easy to secure a higher degree of withstand voltage properties.

(12) In any one of (1) to (11) above, the liquid component may further include a base component. In this case, dissociation properties of the acid component are enhanced, and the conductive polymer is likely to have a higher conductivity.

(13) In (12) above, an equivalent ratio of the first carboxylic acid compound to the base component may be 0.4 or more and 10 or less. In this case, high dissociation properties of the first carboxylic acid compound can be secured. Also, corrosion of electrodes can be suppressed, and it is easy to secure a high degree of withstand voltage properties.

The following describes an electrolytic capacitor according to the present disclosure in more detail. At least one selected from constituent elements described below may be combined with at least one of (1) to (13) described above regarding a solid electrolytic capacitor according to the present disclosure as long as such a combination is technically possible.

### (Liquid Component)

A liquid component included in the electrolytic capacitor includes an acid component and a solvent. The acid component includes a first carboxylic acid compound.

### (Acid Component)

### (First Carboxylic Acid Compound)

A plurality of first moieties included in the first carboxylic acid compound each independently have: a first carboxy group including a first carbonyl group; a second carbonyl group; and a first linking group that links the first carbonyl group and the second carbonyl group. The first carboxy group and the second carbonyl group in each of the plurality of first moieties improve the stability of a conductive polymer, and accordingly, a high conductivity is maintained and a change in the ESR of the electrolytic capacitor over time can be suppressed. Moreover, film repair properties of a dielectric layer are enhanced by the action of the first carboxylic acid compound, and accordingly, an increase in a leakage current can be suppressed even after the electrolytic capacitor is used for a long period of time, and a high degree of withstand voltage properties can be secured.

In a molecule of the first carboxylic acid compound, the first linking groups of all of the plurality of first moieties may have different structures or the first linking groups of at least two first moieties may have the same structure. All compounds having such structures are encompassed in the first carboxylic acid compound according to the present disclosure. If the first linking groups of at least two first moieties have the same structure, the distance between the first carbonyl groups or the first carboxy groups is determined to some extent, and accordingly, the action of the first carboxylic acid compound on the conductive polymer is enhanced, and this configuration is thought to be advantageous from the viewpoint of the stability and high conductivity of the conductive polymer. Also, it is relatively easy to design the molecule of the first carboxylic acid compound and synthesize the first carboxylic acid compound. Note that the case where the first linking groups have the same structure includes a case where the moieties each constituted of the first carbonyl group, the first linking group, and the second carbonyl group have the same structure with these groups arranged in this order.

In the electrolytic capacitor, the first carboxy group may be in a free form, or in the form of a salt or an anion, or in a form interacting (e.g., complexed) with the conductive polymer. In the present specification, the first carboxy group encompasses all of these forms. For example, the first linking groups in two first moieties having the same structure means that the two first moieties have the same structure. However, the case where the two first moieties have the same structure encompasses a case where the first carboxy groups are in the same form and a case where the first carboxy groups are in different forms.

The first carboxylic acid compound may include a second linking group. The second linking group links the second carbonyl groups of the plurality of first moieties in the first carboxylic acid compound. The plurality of carboxy groups are spaced apart from each other to some extent by the second linking group, and therefore, it is thought that the action of the first carboxylic acid compound on the conductive polymer is enhanced. Accordingly, the conductive polymer is further stabilized and the change in the ESR over time can be further suppressed. Also, the plurality of first moieties can be easily introduced into the first carboxylic acid compound by interposing the second linking group between the second carbonyl groups of the plurality of first moieties.

The first carboxylic acid compound encompasses a compound represented by the following formula (IA), for example.

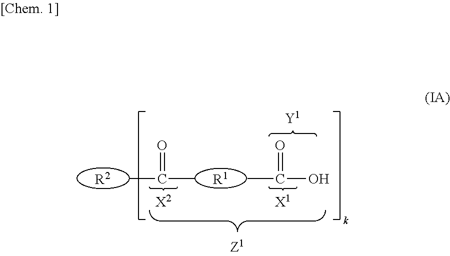

In this formula, X¹ represents the first carbonyl group, X represents the second carbonyl group, Y¹ represents the first carboxy group, R¹ represents the first linking group, R² represents the second linking group, and Z¹ represents the first moiety. k represents the number of first moieties Z¹, and is an integer of 2 or more.

k may be an integer of 2 or more and 8 or less, 2 or more and 6 or less, 2 or more and 4 or less, or 2 or 3. In the formula (IA), at least two first moieties may have the same structure, or all first moieties may have different structures. Although the formula (IA) shows an example in which the first carboxy group is in a free form, the compound represented by the formula (IA) encompasses compounds in which the first carboxy group is in a form other than the free form.

The first carboxylic acid compound encompasses a compound represented by the following formula (I), for example. The formula (I) represents compounds having two first moieties among compounds represented by the formula (IA).

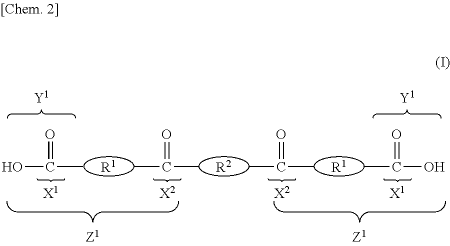

In this formula, each X¹ represents the first carbonyl group, each X² represents the second carbonyl group, each Y¹ represents the first carboxy group, each R¹ independently represents the first linking group, R² represents the second linking group, and each Z¹ independently represents the first moiety.

Note that the above-described case where at least two first linking groups have the same structure includes a case where the structure of the moiety constituted of the first carbonyl group, the first linking group, and the second carbonyl group is the same in the structural formula of the first carboxylic acid compound, as well as a case where the structure is symmetrical with respect to the second linking group. More specifically, the former case corresponds to the case where —X¹—R¹—X²— on the left of the second linking group R² and —X²—R¹—X¹— on the right of the second linking group R² in the above formula (I) have the same structure when these groups are arranged in this order. The latter case corresponds to the case where —X²—R¹—X¹— on both sides of the second linking group R² have the same structure when these groups are arranged in this order.

The compound represented by the formula (I) may be symmetrical (have line symmetry) with respect to the second linking group R², or asymmetrical. Although the formula (I) shows an example in which the first carboxy group is in a free form, the compound represented by the formula (I) encompasses compounds in which the first carboxy group is in a form other than the free form. The above-described case where the compound is symmetrical with respect to the second linking group R² encompasses cases where the first carboxy groups are in forms different from each other.

There is no particular limitation on the structure of the first linking group (R¹ in the formulas (IA) and (I)) and the structure of the second linking group (R² in the formulas (IA) and (I)) as long as the first carboxy group and the second carbonyl group are not hindered from acting on the conductive polymer. The first moieties may be residues of a polycarboxylic acid or an acid anhydride thereof. Also, the plurality of second carbonyl groups and the second linking group linking these second carbonyl groups may be residues of a polycarboxylic acid or an acid anhydride thereof. Examples of these polycarboxylic acids include dicarboxylic acid, tricarboxylic acid, and tetracarboxylic acid (in particular, dicarboxylic acid). When the first moieties are residues of a polycarboxylic acid or an acid anhydride thereof, the second linking group is a residue of a compound (e.g., a polyol compound or a polyamine compound) that can be linked with the polycarboxylic acid or the acid anhydride thereof. When the plurality of second carbonyl groups and the second linking group linking these second carbonyl groups are residues of a polycarboxylic acid or an acid anhydride thereof, the moiety constituted of the first linking group and the first carboxy group is a residue of a compound (e.g., a hydroxycarboxylic acid compound or an amino carboxylic acid compound) that can be linked with the polycarboxylic acid or the acid anhydride thereof. From the viewpoint of ease of the design of the molecule of the first carboxylic acid compound or ease of the synthesis of the first carboxylic acid compound, it is preferable that the first moieties are residues of a polycarboxylic acid (in particular, dicarboxylic acid) or an acid anhydride thereof.

Each of the plurality of first linking groups (R¹ in the formulas (IA) and (I)) may have a main chain and a substituent (including a side chain) linked to the main chain, or may be constituted of only the main chain (corresponding to a case where the first linking group does not have a substituent). Hereinafter, the substituent (including a side chain) linked to the main chain may also be referred to as a “first substituent”. The main chain links a carbon atom (a first carbon atom) in the first carbonyl group and a carbon atom (a second carbon atom) in the second carbonyl group. The main chain is a straight chain having at least a carbon atom, and the first carbon atom and the second carbon atom are not included in the main chain. Also, the first substituent is not included in the main chain. Note that the main chain encompasses chains having only one carbon atom (e.g., a methylene group, a methylene group having the first substituent, and a group including a methylene group and a heteroatom, which will be described later (e.g., an oxymethylene group and an oxymethylene group having the first substituent)). When there are a plurality of chains linking the first carbon atom and the second carbon atom, a chain having the smallest number of atoms (e.g., carbon atoms, heteroatoms, which will be described later, etc.) is taken to be the main chain. Note that the first substituent may further have a substituent (a second substituent).

The main chain may be a hydrocarbon chain or include a heteroatom. At least one selected from the group consisting of an oxygen atom, a sulfur atom, a nitrogen atom, a silicon atom, and the like is included as the heteroatom. The main chain may include one hetero element or two or more hetero elements. The main chain may be a straight chain or constitute a part of a ring structure. The main chain may constitute a part of at least one ring structure selected from the group consisting of non-aromatic rings and aromatic rings. These rings may be hydrocarbon rings or hetero rings including hetero elements. Also, these rings may be cross-linked rings or condensed rings. For example, at least one selected from the group consisting of an oxygen atom, a sulfur atom, a nitrogen atom, and the like is included as a heteroatom in the hetero rings. The hetero rings may include one hetero element or two or more hetero elements. Examples of the hetero rings include divalent groups corresponding to hetero ring groups described later about the first substituent, and the description of hetero rings of the first substituent can be referred to.

For example, when the first linking group is a 1,1-dimethylethane-1,2-diyl group, a 1,2-ethylene group other than two methyl groups corresponding to substituents constitutes the main chain. When the first carbonyl group and the second carbonyl group are linked to the 1- and 2-positions of cyclohexane, respectively, the series of carbon atoms at the 1- and 2-positions of cyclohexane is the main chain, and the number of carbon atoms included in the main chain is two. In this case, the first linking group is a cyclohexane-1,2-diyl group. When the first linking group is a 2-norbornene-5,6-diyl group, the series of carbon atoms at the 5- and 6-positions of the norbornene ring is the main chain, and the number of carbon atoms included in the main chain is two. When the first linking group is a 1,2-phenylene group, the series of carbon atoms at the 1- and 2-positions of the benzene ring is the main chain, and the number of carbon atoms included in the main chain is two. It is preferable that the main chain is an alkylene group, an alkenylene group, an oxyalkylene group, a polyoxyalkylene group, or the like. These groups may constitute a part of a ring structure. Note that, in the oxyalkylene group or the polyoxyalkylene group, the oxy group is linked to the second carbon atom, and the alkylene group is linked to the first carbon atom.

In each first linking group, the number of carbon atoms included in the main chain may be 1 or more and 10 or less, 1 or more and 6 or less, or 1 or more and 4 or less. In the first linking groups of at least two first moieties, the number of carbon atoms included in the main chain is preferably 1 or more and 4 or less, and may be 2 or more and 4 or less. If the number of carbon atoms included in the main chain is 4 or less, the distance between the first carboxy group and the second carbonyl group is relatively short, and accordingly, a stabilized structure is likely to be formed when the first carboxy group is ionized, and acidity is likely to be maintained around the conductive polymer. Therefore, deterioration of the conductive polymer is suppressed, and the effect of maintaining a high conductivity is further enhanced. In the first carboxylic acid compound, the number of carbon atoms included in the main chain of the first linking group may be the same in at least two first moieties, or may be different in all of the first moieties.

The first linking group may also include a cyclic divalent group (e.g., a non-aromatic cyclic divalent group or an aromatic divalent group). The first linking groups of at least two first moieties may include these cyclic divalent groups. These cyclic divalent groups may be divalent hydrocarbon ring groups or divalent hetero ring groups. If the first linking group includes such a cyclic divalent group, it is easy to adjust solubility of the first carboxylic acid compound in a solvent and affinity of the first carboxylic acid compound to the dielectric layer. If the first linking group includes such a cyclic divalent group, the first carboxy group is likely to be stabilized due to the bulky ring, and the positions of the second carbonyl group and the first carboxy group are likely to be fixed. Therefore, the liquid component tends to have a low pH, and it is easy to stabilize the conductive polymer. For example, the first linking group may include a non-aromatic or aromatic divalent hydrocarbon ring group (cyclohexane-1,2-diyl, 2-norbornene-5,6-diyl, 1,2-phenylene, etc.) or a non-aromatic or aromatic divalent hetero ring group. The non-aromatic cyclic divalent group or the aromatic divalent group may further have a substituent (a third substituent). Also, the first linking group may have a structure in which the non-aromatic cyclic divalent group or the aromatic divalent group is linked to an aliphatic divalent group. The aliphatic divalent group constitutes a part of the main chain of the first linking group. The first linking group may have a structure in which an aliphatic divalent group is linked to a non-aromatic cyclic divalent group or aromatic divalent group, or a structure in which two aliphatic divalent groups are respectively linked to bonds of a non-aromatic cyclic divalent group or aromatic divalent group. The aliphatic divalent group may also have a first substituent.

It is also preferable that the main chain of the first linking group is an aliphatic divalent group. In the first linking groups of at least two first moieties, the main chain may be an aliphatic divalent group. In these cases, it is possible to improve the function of the liquid component repairing the dielectric layer and further enhance the effect of suppressing a leakage current when a high voltage is applied. The aliphatic divalent group may also have a first substituent.

The first substituent of the main chain of the first linking group is, for example, a hydrocarbon group, a hetero ring group, a R³—O— group (e.g., an alkoxy group), a R⁴—O—C(═O)— group (e.g., an alkoxycarbonyl group), a R⁵—C(═O)— group (e.g., an acyl group), a carboxy group, a hydroxy group, or a halogen atom (e.g., a fluorine atom, a chlorine atom, a bromine atom, or an iodine atom). The first substituent is typically a monovalent group. R³, R⁴, and R⁵ each represent a hydrocarbon group, for example.

A hydrocarbon group included as the first substituent and hydrocarbon groups represented by R³, R⁴, and R⁵ may be saturated or unsaturated. Examples of these hydrocarbon groups include non-aromatic hydrocarbon groups (e.g., aliphatic hydrocarbon groups and alicyclic hydrocarbon groups) and aromatic hydrocarbon groups. The aliphatic hydrocarbon groups may be linear or branched. Examples of the aliphatic hydrocarbon groups include alkyl groups and unsaturated aliphatic hydrocarbon groups (an alkenyl group, a dienyl group, a trienyl group, etc.). Examples of the alkyl groups include a methyl group, an ethyl group, an n-propyl group, an isopropyl group, an n-butyl group, an isobutyl group, a sec-butyl group, a tert-butyl group, a pentyl group, a hexyl group, a heptyl group, an n-octyl group, a 2-ethylhexyl group, a nonyl group, a decyl group, an undecyl group, a lauryl group (a dodecyl group), and a myristyl group. Examples of the unsaturated aliphatic hydrocarbon groups include a vinyl group, an allyl group, a hexenyl group, a 2-octenyl group, a 2,4,6-trimethylnonane-2-en-1-yl group, a decenyl group, a dodecenyl group (including a 2-dodecenyl group and a tetrapropenyl group), and a tetradecenyl group. The number of carbon atoms included in the aliphatic hydrocarbon groups (monovalent aliphatic hydrocarbon groups) may be 1 or more, or 6 or more. The number of carbon atoms included in the aliphatic hydrocarbon groups (monovalent aliphatic hydrocarbon groups) may be 12 or less, 8 or less, or 5 or less. The number of carbon atoms included in the aliphatic hydrocarbon groups (monovalent aliphatic hydrocarbon groups) may be 1 or more and 12 or less, 1 or more and 8 or less, 1 or more and 5 or less, or 6 or more and 12 or less. Examples of the alicyclic hydrocarbon groups include cycloalkyl groups (e.g., a cyclohexyl group), cycloalkenyl groups (e.g., a cyclohexenyl group), cycloalkadienyl groups (e.g., a cyclopentadienyl group), and cross-linked cyclic hydrocarbon groups (e.g., a norbornyl group, a norbornenyl group, and a dicyclopentadienyl group). The number of carbon atoms included in the alicyclic hydrocarbon groups may be 5 or more and 16 or less, 5 or more and 12 or less, or 5 or more and 10 or less. Examples of the aromatic hydrocarbon groups include aryl groups (e.g., a phenyl group and a naphthyl group). The number of carbon atoms included in the aromatic hydrocarbon groups may be 6 or more and 14 or less, or 6 or more and 10 or less.

A hetero ring group included as the first substituent is a monovalent hetero ring group including a heteroatom as a constituent atom of the ring. For example, at least one selected from the group consisting of an oxygen atom, a sulfur atom, and a nitrogen atom is included as the heteroatom. The hetero ring group may include one heteroatom or two or more heteroatoms. The hetero ring group may be saturated or unsaturated. The hetero ring group may be non-aromatic or aromatic. The hetero ring group may be constituted of 5 to 14 members or 5 to 10 members, for example. Examples of the hetero ring group include oxygen-containing ring groups (e.g., a furanyl group and a tetrahydrofuranyl group), sulfur-containing ring groups (e.g., a thiophene-3-yl group), and nitrogen-containing ring groups (e.g., a pyrrolidinyl group, a piperidinyl group, a pyridyl group, and a morpholinyl group).

When the main chain of the first linking group is an aliphatic divalent group, the aliphatic divalent group may have a monovalent aliphatic hydrocarbon group having 6 or more carbon atoms as at least one first substituent. In the first linking groups of at least two first moieties, the main chain may be an aliphatic divalent group and have a monovalent aliphatic hydrocarbon group having 6 or more carbon atoms as at least one first substituent. In these cases, the withstand voltage properties of the electrolytic capacitor can be further improved. A first carboxylic acid compound that has an aliphatic divalent group as the main chain of the first linking group has a relatively low effect of reducing the pH of the liquid component, and the first carboxy group tends to be esterified. If at least one first substituent is an aliphatic hydrocarbon group having 6 or more carbon atoms, an effect of suppressing the esterification is enhanced, and a higher conductivity of the conductive polymer can be secured. It is preferable that the first linking group has the first substituent at the α position of the first carbonyl group. If the first linking group has an aliphatic hydrocarbon group having 6 or more carbon atoms as the first substituent at the α position of the first carbonyl group, the effect of suppressing esterification of the first carboxy group is further enhanced by the aliphatic hydrocarbon group that serves as a steric hindrance. Therefore, the action of the first carboxylic acid compound on the conductive polymer is maintained, and the effect of suppressing the change in the ESR is enhanced.

Note that a high effect of suppressing the change in the ESR tends to be achieved as described above not only when an aliphatic hydrocarbon group having 6 or more carbon atoms is included as the first substituent but also when a first substituent that may be a steric hindrance is included at the α position of the first carbonyl group. For example, two first substituents may be included at the α position of the first carbonyl group. Also, a first substituent such as a tert-butyl group or a cyclic group (e.g., an alicyclic hydrocarbon group, an aromatic hydrocarbon group, or a hetero ring group) may be included at the α position of the first carbonyl group. Also, an alkyl group (e.g., an alkyl group having 1 to 3 carbon atoms) that has a cyclic group (e.g., an alicyclic hydrocarbon group, an aromatic hydrocarbon group, or a hetero ring group) as the second substituent may be included as the first substituent at the α position of the first carbonyl group.

The number of first substituents per first linking group is 1 or more, for example. The upper limit of the number of first substituents per first linking group is not particularly limited, and may be determined according to the length of the main chain. The number of first substituents may be 6 or less, or 3 or less.

When the first substituent is a hydrocarbon group, the second substituent is at least one selected from the group consisting of hydrocarbon groups other than the first substituent and groups (or atoms) other than hydrocarbon groups out of the groups (or the atoms) listed as examples of the first substituent, for example. When the first substituent is a hetero ring group, the second substituent is at least one selected from the group consisting of groups (or atoms) other than hetero ring groups out of the groups (or the atoms) listed as examples of the first substituent, for example.

The third substituent can be selected from the substituents listed as examples of the first substituent or the second substituent.

Examples of the polycarboxylic acid corresponding to the first moieties include succinic acid, succinic acid having an alkyl group or an alkenyl group as the first substituent (e.g., 2,2-dimethylsuccinic acid, 2-n-butylsuccinic acid, 2-n-octylsuccinic acid, 2-n-dodecylsuccinic acid, 2-(2′-octenyl)succinic acid, or 2-(2′-dodecenyl)succinic acid), apolycarboxylic acid having an alicyclic hydrocarbon group as the first substituent (e.g., 2-n-cyclohexylsuccinic acid), a polycarboxylic acid having an aromatic hydrocarbon group as the first substituent (e.g., 2-phenylsuccinic acid), and a polycarboxylic acid in which the first linking group includes a cyclic divalent group (e.g., 1,2-cyclohexane dicarboxylic acid, 5-norbornene-2,3-dicarboxylic acid, or phthalic acid). Acid anhydrides of these polycarboxylic acids may be used to form the first moieties. However, these are merely examples, and the polycarboxylic acid or an acid anhydride thereof corresponding to the first moieties is not limited to these examples.

It is preferable that the second linking group is a residue of a polyol compound or a polyamine compound. Such a second linking group has an oxygen atom or an amino group linked to the second carbonyl group of each of the first linking groups. In this case, it is possible to easily introduce the first moieties into the first carboxylic acid compound through ester bonds or amide bonds. The amino group includes >N— and —NH—, for example.

The valence of the second linking group corresponds to the number of first moieties (k in the formula (IA)) included in the first carboxylic acid compound. For example, when the first carboxylic acid compound includes two first moieties, the second linking group is a divalent group. When the first carboxylic acid compound includes three first moieties, the second linking group is a trivalent group, and when the first carboxylic acid compound includes four fust moieties, the second linking group is a tetravalent group.

The second linking group may be a chain group or include a ring structure. The ring structure may constitute apart of a main chain of the second linking group. Also, the second linking group may have the main chain and a substituent (a fourth substituent) linked to the main chain. The second linking group may have a ring structure (a cyclic group) as the fourth substituent. The second linking group may be saturated or unsaturated. The ring structure may be saturated or unsaturated. The second linking group may include a heteroatom in the main chain in addition to the oxygen atom or the amino group linked to the second carbonyl group. Examples of the heteroatom include an oxygen atom and a nitrogen atom. The fourth substituent can be selected from the substituents listed as examples of the first substituent or the second substituent, an oxo group (═O), and the like. When the second linking group has the fourth substituent, the number of fourth substituents is 1 or more, for example, and may be 1 or more and 6 or less, or 1 or more and 4 or less.

Examples of the polyol compound corresponding to the second linking group include aliphatic polyols (e.g., alkane polyols and alkene diols), alicyclic polyols, aromatic polyols, alkylene oxide adducts of these polyols, and polyalkylene glycols. Examples of the alkane polyols include alkane diols (e.g., ethylene glycol, propylene glycol, trimethylene glycol, 1,4-butanediol, 1,6-hexanediol, 1,8-octanediol, 2-ethyl-1,3-hexanediol, 1,9-nonanediol, and 2-butyl-2-ethyl-1,3-propanediol), glycerin, polyglycerins (e.g., diglycerin, triglycerin, and tetraglycerin), trimethylolpropane, sugar or sugar alcohols (e.g., mannitol, erythritol, xylitol, and pentaerythritol). The number of carbon atoms included in the alkane polyols may be 1 or more and 12 or less, or 1 or more and 10 or less (or 9 or less). The number of carbon atoms may also be 2 or more in these ranges. Examples of the alkene diols include 1,4-dihydroxybutane-2-en. The number of carbon atoms included in the alkene diols may be 2 or more and 12 or less, or 2 or more and 10 or less (or 9 or less). Examples of the polyalkylene glycols include polyethylene glycols, polypropylene glycols, and polytrimethylene glycols. Examples of the polyalkylene glycols include poly(C₂₋₄-alkylene glycol). The number of repetitions of an oxyalkylene group (e.g., an oxyalkylene group having 2 to 4 carbon atoms) in the polyalkylene glycols is 2 or more, and may be 2 or more and 10 or less, or 2 or more and 6 or less. Specific examples of the polyethylene glycols include diethylene glycol and triethylene glycol. Specific examples of the polypropylene glycols include dipropylene glycol and tripropylene glycol. Specific examples of the polytrimethylene glycols include di(trimethylene glycol) and tri(trimethylene glycol). The alicyclic polyols include polyhydroxycycloalkanes (e.g., polyhydroxycycloalkanes having 5 to 10 carbon atoms such as dihydroxycyclohexane and trihydroxycyclohexane), polyhydroxycycloalkenes (e.g., polyhydroxycycloalkenes having 5 to 10 carbon atoms such as dihydroxycyclohexene), as well as poly(hydroxyalkyl)cycloalkane (e.g., poly(hydroxy-C₁₋₄-alkyl)C₅₋₁₀-cycloalkane) such as cyclohexane dimethanol. Examples of the aromatic polyols include dihydroxybenzene, biphenol, and bisphenol, as well as poly(hydroxyalkyl)arene (e.g., poly(hydroxy-C₁₋₄-alkyl)C₆₋₁₀-arene) such as xylylene glycol.

Examples of the alkylene oxide adducts include compounds (excluding the above-listed polyalkylene glycols) obtained by adding at least one or at least two alkylene oxides (e.g., C₂₋₄-alkylene oxides such as ethylene oxide and propylene oxide) per hydroxy group to the hydroxy groups of the above-listed polyols. The number of alkylene oxides added per hydroxy group is 6 or less, for example, and may be 4 or less, or 3 or less. The lower limit and the upper limit of the number of alkylene oxides can be combined suitably. In the first carboxylic acid compound, the first moieties may be introduced into all hydroxy groups of the polyol compound corresponding to the second linking group, or the first moieties may be introduced into some of the hydroxy groups.

It is preferable that, in the polyamine compound corresponding to the second linking group, at least two amino groups are amino groups (>NH, —NH₂) that have active hydrogen. Examples of the polyamine compound corresponding to the second linking group include aliphatic polyamines, polyalkylene polyamines, alicyclic polyamines, aromatic polyamines, and cyclic amines. Examples of the aliphatic polyamines include alkylene diamines (e.g., ethylene diamine, 1,4-diaminobutane, and N,N′-dialkylalkylenediamine), triaminoalkanes, and tetraaminoalkanes. Examples of the alkylene diamines include C₂₋₆-alkylene diamine (e.g., C₂₋₄-alkylene diamine). Examples of the N,N′-dialkylalkylenediamine include N,N′-di-C₁₋₆-alkyl-C₂₋₆-alkylenediamine (e.g., N,N′-di-C₁₋₄-alkyl-C₂₋₄-alkylenediamine) such as N,N′-dialkylethylenediamine. Specific examples of the N,N′-dialkylalkylenediamine include N,N′-diethylethylenediamine, N,N′-diisopropylethylenediamine, and N,N′-di-t-butylethylenediamine. The number of carbon atoms included in the aliphatic polyamines may be 1 or more and 10 or less, or 2 or more and 6 or less. Examples of the alicyclic polyamines include polyaminocycloalkanes (e.g., polyamino-C₅₋₁₀-cycloalkanes such as diaminocyclohexane) and polyaminocycloalkenes (e.g., polyamino-C₅₋₁₀-cycloalkenes such as diaminocyclohexene). Examples of the aromatic polyamines include polyaminoarenes (e.g., polyamino-C₆₋₁₀-arenes such as 1,4-phenylenediamine and triaminobenzene). Examples of the cyclic amines include compounds that have a —NH group and at least one —NH group or —NH₂ group. Examples of such compounds include cyclic amines (e.g., cytosine, guanine, and adenine) and cyclic polyamines (e.g., piperazine, thymine, and uracil). The cyclic amines may include 5 to 12 members or 5 to 10 members.

The liquid component may include, for example, at least one selected from the group consisting of a compound represented by the following formula (Ia) and a compound represented by the following formula (Ib) as the first carboxylic acid compound.

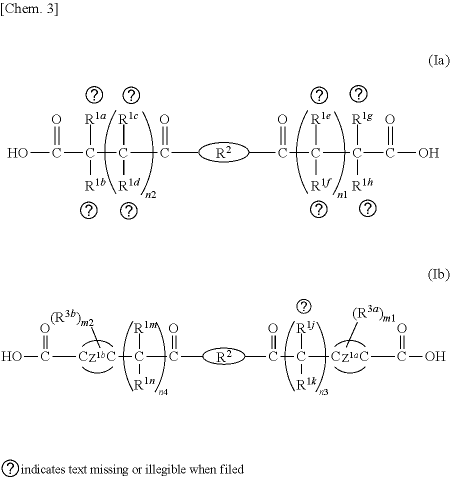

In these formulas, R^{1a} to R^{1h}, R^{1j}, R^{1k}, R^{1m}, and R¹ⁿ each independently represent a hydrogen atom or a first substituent, and n1 to n4 represent the numbers of repetitions of methylene chains that may have the first substituents. Rings Z^{1a} and Z^{1b} each independently represent a cyclic divalent group (e.g., a non-aromatic cyclic divalent group or an aromatic divalent group) included in the first linking group. R^{3a} and R^{3b} represent third substituents included in the rings Z^{1a} and Z^{1b}, respectively, and m1 and m2 represent the numbers of third substituents included in the rings Z^{1a} and Z^{1b}, respectively. R² represents the second linking group.

The formula (Ia) corresponds to the case where the main chain of the first linking group is an aliphatic divalent group in the formula (I). n1 and n2 are integers of 0 or more, and may be integers of 1 or more. (n1+1) and (n2+1) each correspond to the number of carbon atoms included in the main chain of the first linking group described above. Each of n1 and n2 may be 1 or more and 5 or less, or 1 or more and 3 or less, for example. When n1 is 2 or more, at least two R^{1c} linked to carbon atoms included in the main chain may be the same as each other, or all R^{1c} may be different from each other. Likewise, when n1 is 2 or more, at least two R^{1d} linked to carbon atoms included in the main chain may be the same as each other, or all R^{1d} may be different from each other. Likewise, when n2 is 2 or more, at least two R^{1g} (or R^{1h}) linked to carbon atoms included in the main chain may be the same as each other, or all R^{1g} (or R^{1h}) may be different from each other.

It is preferable that the compound represented by the formula (Ia) has a first substituent at least at the α position of the first carbonyl group. In other words, it is preferable that at least one of R^{1a} and R^{1b} is the first substituent. Also, it is preferable that at least one of R^{1e} and R^{1f} is the first substituent. It is preferable that the compound has at least one first substituent that may be a steric hindrance at the α position of the first carbonyl group, as well as an aliphatic hydrocarbon group having 6 or more carbon atoms. In this case, one of R^{1a} and R^{1b} may be an aliphatic hydrocarbon group having 6 or more carbon atoms or the first substituent that may be a steric hindrance, and the other may be a hydrogen atom. Also, one of R^{1e} and R^{1f} may be an aliphatic hydrocarbon group having 6 or more carbon atoms or the first substituent that may be a steric hindrance, and the other may be a hydrogen atom. In these cases, each of R^{1c} and R^{1d} may be a hydrogen atom or a first substituent irrespective of the number represented by n1, but a configuration is also possible in which R^{1c} and R^{1d} are hydrogen atoms. Likewise, each of R^{1g} and R^{1h} may be a hydrogen atom or a first substituent irrespective of the number represented by n2, but a configuration is also possible in which R^{1g} and R^{1h} are hydrogen atoms.

The formula (Ib) corresponds to the case where the first linking group includes a non-aromatic cyclic divalent group or an aromatic divalent group in the formula (I). n3 and n4 are integers of 0 or more. A value obtained by adding the smallest number of carbon atoms between two bonds of the ring Z^{1a} (or the ring Z^{1b}) to n3 (or n4) corresponds to the number of carbon atoms included in the main chain of the first linking group described above. Each of n3 and n4 may be 0 or more and 4 or less, or 0 or more and 2 or less, for example. When n3 (or n4) is 2 or more, at least two R^{1j} (or R^{1m}) linked to carbon atoms included in the main chain may be the same as each other, or all R^{1j} (or R^{1m}) may be different from each other. Likewise, when n3 (or n4) is 2 or more, at least two R^{1k} (or R¹ⁿ) linked to carbon atoms included in the main chain may be the same as each other, or all R^{1k} (or R¹ⁿ) may be different from each other.

In the formula (Ib), m1 and m2 corresponding to the numbers of third substituents are integers of 0 or more. The upper limit of the number of third substituents can be selected according to the number of members included in the ring Z^{1a} or the ring Z^{1b}. When the ring Z^{1a} (or the ring Z^{1b}) has a plurality of third substituents R^{3a}, at least two of the plurality of third substituents R^{3a} may be the same as each other or all of the third substituents R^{3a} may be different from each other.

The compound represented by the formula (Ib) may be a compound represented by the following formula (ib), for example.

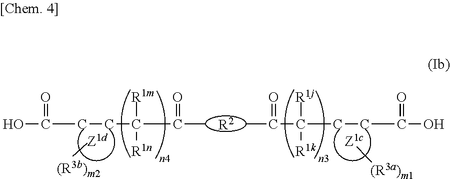

In this formula, the rings Z^{1c} and Z^{1d} each independently represent a non-aromatic cyclic divalent group or an aromatic divalent group included in the first linking group. R^{1j}, R^{1k}, R^{1m}, R¹ⁿ, n3, n4, R^{3a}, R^{3b}, m1, m2, and R² are as described above.

As for the formula (ib), (n3+2) and (n4+2) each correspond to the number of carbon atoms included in the main chain of the first linking group.

In each of the formulas (Ia) and (Ib) (including the formula (ib)), the structures of the two first linking groups may be the same as each other (including the case where the structures are symmetrical with respect to the second linking group) or different from each other.

As for the second linking group R² in the formulas (Ta) and (Ib) (including the formula (ib)), the above description of the second linking group can be referred to. The second linking group R2 may be a divalent group represented by any of the following formulas (iia) to (iid), for example. In these divalent groups, * represents bonds to the first carbonyl group and the second carbonyl group.

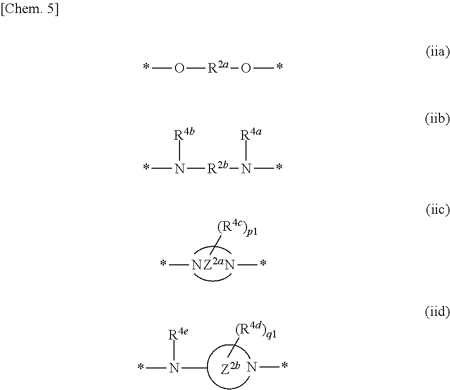

The second linking group represented by the formula (ia) corresponds to a residue of the polyol compound (e.g., a diol compound) described above. The second linking groups represented by the formulas (iib) to (iid) correspond to residues of the polyamine compound described above. R^{2a} may be a chain group or a group including a ring structure. R^{2a} may also have the fourth substituent described above. The formulas (iic) and (iid) represent groups corresponding to the cyclic amines described above. R^{4a}, R^{4b}, and R^{4c} each independently represent a hydrogen atom or the fourth substituent. The rings Z^{2a} and Z^{2b} correspond to ring structures (specifically, nitrogen-containing rings) included in the second linking groups. R^{4c} and R^{4d} independently represent the fourth substituents included in the rings Z^{2a} and Z^{2b}, respectively. p1 representing the number of fourth substituents R^{4c} and q1 representing the number of fourth substituents R^{4d} are each an integer of 0 or more. The upper limits of p1 and q1 may be determined according to the numbers of members included in the rings Z^{2a} and Z^{2b}, respectively.

Although the formulas (I), (Ia), (Ib), and (ib) show examples in which the second linking group is a divalent group and the first carboxylic acid compound includes two first moieties, the first carboxylic acid compound is not limited to these examples. The first carboxylic acid encompasses a compound in which the second linking group is a polyvalent group whose valence is three or more (e.g., a residue of a polyol compound having three or more hydroxy groups or a residue of a polyamine compound having three or more amino groups) and that includes two or more first moieties. As for such a compound as well, the descriptions about the formulas (I), (Ia), (Ib), and (ib) can be referred to. In such a compound, at least two of the two or more first moieties may be the same as each other, or all of the first moieties may be different from each other.

When the second linking group in the first carboxylic acid compound is a residue of a polyol compound or a residue of a polyamine compound, each hydroxy group or each amino group that is not linked to the first moieties may be in a free form. Alternatively, each hydroxy group or each amino group that is not linked to the first moieties may be etherified or esterified, may form an amino bond or a salt, or may be protected. Each hydroxy group or each amino group that is not linked to the first moieties may interact with or be linked to a component that is present in the process of generation, or may interact with or be linked to another component included in the electrolytic capacitor.

The acid component may include one first carboxylic acid compound or a combination of two or more first carboxylic acid compounds.

### (Second Carboxylic Acid Compound)

The acid component may further include a second carboxylic acid compound that differs from the first carboxylic acid compound. If the acid component includes the second carboxylic acid compound, the pH of the liquid component can be further reduced, and accordingly, the reduction in the conductivity of the conductive polymer is further suppressed while the withstand voltage properties are secured to some extent due to the action of the first carboxylic acid compound, and therefore, it is easy to further suppress the change in the ESR over time.

Examples of the second carboxylic acid compound include carboxylic acids other than the first carboxylic acid compound, carboxylic acid anhydrides, coordination compounds of carboxylic acids, and a carboxylic acid compound (second carboxylic acid compound B) including one first moiety. Second carboxylic acid compounds other than the second carboxylic acid compound B may be referred to as second carboxylic acid compounds A.

Among the second carboxylic acid compounds A, examples of the carboxylic acids include aliphatic carboxylic acids and aromatic carboxylic acids. Examples of the aromatic carboxylic acids include aromatic hydroxy acids (e.g., benzoic acid and salicylic acid), aromatic polycarboxylic acids (e.g., phthalic acid and pyromellitic acid), and sulfo-aromatic carboxylic acids (e.g., p-sulfobenzoic acid, 3-sulfophthalic acid, and 5-sulfosalicylic acid). Examples of the coordination compounds include coordination compounds that include at least one central atom selected from the group consisting of boron, aluminum, and silica, and an acid having a carbonyloxy bond that is linked to the central atom. Specific examples of the coordination compounds include borodisalicylic acid, borodioxalic acid, borodiglycolic acid, and borodigallic acid.

The second carboxylic acid compound B includes the first moiety and an organic group linked to the first moiety, for example. The organic group is represented by R^{2b}—X—. —X— is —O— or —N(—R^{4f})—, for example, and is linked to the second carbonyl group of the first moiety. The organic group may be a residue of a hydroxy compound (a monohydroxy compound or a polyol compound) or a residue of an amine compound (a monoamine compound or a polyamine compound). As for R^{4f}, the descriptions about R^{4a} and R^{4b} can be referred to. R^{4f} may be a hydrogen atom or the fourth substituent. The organic group may be a monovalent group corresponding to the second linking group (e.g., R²) of the first carboxylic acid compound.

As for the second carboxylic acid compound B, the descriptions about the first moieties and the second linking group of the first carboxylic acid compound can be referred to. Examples of the second carboxylic acid compound B include monoesters produced from an alkylene glycol or a polyalkylene glycol and a polycarboxylic acid (e.g., a monoester produced from ethylene glycol and octenylsuccinic acid, a monoester produced from triethylene glycol and octenylsuccinic acid, a monoester produced from tripropylene glycol and octenylsuccinic acid, a monoester produced from triethylene glycol monomethyl ether and octenylsuccinic acid, a monoester produced from ethylene glycol and 1,2-cyclohexane dicarboxylic acid, and a monoester produced from ethylene glycol and phthalic acid), monoesters produced from a monovalent alcohol and a polycarboxylic acid (e.g., a monoisodecyl ester of octenylsuccinic acid), monoamides produced from a monoamine and a polycarboxylic acid (e.g., a monoamide produced from diethylamine and octenylsuccinic acid), and monoamides produced from a polyamine and a polycarboxylic acid (e.g., a monoamide produced from ethylenediamine and octenylsuccinic acid). However, these are merely examples, and the second carboxylic acid compound B is not limited to these examples.

The acid component may include one second carboxylic acid compound or two or more second carboxylic acid compounds. Out of the second carboxylic acid compounds, aromatic carboxylic acids (e.g., phthalic acid, salicylic acid, and benzoic acid) and the coordination compounds (e.g., borodisalicylic acid, borodioxalic acid, and borodiglycolic acid) listed above are preferable, and in particular, phthalic acid, salicylic acid, borodisalicylic acid, and the like are preferable. The acid component may include one second carboxylic acid compound A or two or more second carboxylic acid compounds A. Also, the acid component may include one second carboxylic acid compound B or two or more second carboxylic acid compounds B.

In the liquid component, a carboxy group and other acid groups (e.g., a sulfonic acid group, a phosphoric acid group, a phosphonic acid group, etc.) included in the second carboxylic acid compound may each be in a free form, or in the form of a salt or an anion, or in a form interacting (e.g., complexed) with the conductive polymer. The carboxy group and the other acid groups included in the second carboxylic acid compound each encompass all of these forms.

### (Other Acids)

The acid component may include an acid other than the first carboxylic acid compound and the second carboxylic acid compound. Examples of such an acid include acids having a carbonyloxy bond other than carboxylic acids (e.g., oxocarbonic acid and Meldrum's acid) and coordination compounds thereof, phenolic compounds (e.g., picric acid, p-nitrophenol, pyrogallol, and catechol) and coordination compounds thereof, sulfur-containing acids (e.g., sulfuric acid, sulfonic acid (e.g., aromatic sulfonic acid), oxyaromatic sulfonic acid (e.g., phenol-2-sulfonic acid)), compounds having a sulfonylimide bond, boron-containing acids (e.g., boric acid, halogenated boric acid (e.g., tetrafluoroboric acid), and partial esters thereof), phosphorus-containing acids (e.g., phosphoric acid, halogenated phosphoric acid (e.g., hexafluorophosphoric acid), phosphonic acid, phosphinic acid, and partial esters thereof), and nitrogen-containing acids (e.g., nitric acid and nitrous acid).

Examples of the compounds having a sulfonylimide bond include saccharin, 1,2-benzenedisulfonic imide, cyclohexafluoropropane-1,3-bis(sulfonyl)imide, 4-methyl-N-[(4-methylphenyl)sulfonyl]benzenesulfonamide, dibenzenesulfonimide, trifluoromethanesulfonanilide, N-[(4-methylphenyl)sulfonyl]acetamide, benzenesulfonanilide, and N,N′-diphenylsulfamide.

Examples of the coordination compounds include coordination compounds that include at least one central atom selected from the group consisting of boron, aluminum, and silica, and an acid having a carbonyloxy bond or a phenolic compound that is linked to the central atom. Specific examples of the coordination compounds include borodicatechol and borodipyrogallol.

The acid component may include one or two or more of the other acids listed above.

The percentage of the first carboxylic acid compound in the acid component may be 20% by mass or more, or 33% by mass or more. In this case, the effect of suppressing the change in the ESR over time is further enhanced. Also, it is easy to secure a higher degree of withstand voltage properties. The percentage of the first carboxylic acid compound in the acid component is 100% by mass or less, and may be 80% by mass or less from the viewpoint of securing a higher degree of withstand voltage properties and improving the film repair properties of the dielectric layer. The lower limit and the upper limit can be combined suitably.

A mass ratio of the second carboxylic acid compound to the first carboxylic acid compound (=second carboxylic acid compound/first carboxylic acid compound) may be 0/100 or more and 80/20 or less, or 20/80 or more and 67/33 or less. If the mass ratio is within these ranges, the action of the first carboxylic acid compound is likely to be exhibited, and the effect of suppressing the change in the ESR over time is enhanced while a high degree of withstand voltage properties is secured.

A mass ratio of the second carboxylic acid compound B to the first carboxylic acid compound (=second carboxylic acid compound B/first carboxylic acid compound) may be 0/100 or more and less than 50/50, 0.1/99.9 or more and 30/70 or less, or 1/99 or more and 20/80 or less. If the mass ratio is within these ranges, it is possible to further suppress the change in the ESR over time and a leakage current.

The percentage and mass ratios described above are values calculated based on masses of the acids that are in a free form.

### (Oligomer Component)

The liquid component may further include an oligomer component of the first carboxylic acid compound. When the oligomer component includes an oligomer having a carboxy group, this oligomer is encompassed in the second carboxylic acid compound. The oligomer has a repeating structure of the first moiety and the second linking group, for example. For example, if the second linking group is a residue of a polyol compound, the oligomer has a structure in which a polycarboxylic acid or an acid anhydride thereof corresponding to the first moiety and the polyol compound are alternately linked via an ester bond. If the second linking group is a residue of a polyamine compound, the oligomer has a structure in which a polycarboxylic acid or an acid anhydride thereof corresponding to the first moiety and the polyamine compound are alternately linked via an amide bond. The oligomer component may include one type of oligomer or two or more types of oligomers having different structures or different chain lengths.

### (Base Component)

The liquid component may further include a base component. In this case, dissociation properties of the acid component such as the first carboxylic acid compound are enhanced, and the action of acid groups such as the carboxy group to the conductive polymer is enhanced. Accordingly, the conductive polymer is likely to have a higher conductivity.

Examples of the base component include ammonia, amines (specifically, primary amines, secondary amines, and tertiary amines), quaternary ammonium compounds, and amidinium compounds. The liquid component may include one base component or two or more base components.

The liquid component may include any of aliphatic amines, aromatic amines, and heterocyclic amines. Examples of the amines include dialkylamines (e.g., diethylamine), trialkylamines (e.g., trimethylamine, ethyldimethylamine, triethylamine (TEA), tri-n-butylamine (TBA), dimethyl-n-octylamine (DMOA), etc.), alkylenediamines (e.g., ethylenediamine), aromatic amines (e.g., aniline), and heterocyclic amines (e.g., pyrrolidine, imidazole compounds (e.g., imidazole (Imd), 1,2,3,4-tetramethylimidazolinium, etc.), pyridine (Pyr), 4-dimethylaminopyridine, diazabicycloundecene (DBU), etc.). The aromatic amines and the heterocyclic amines may have a monocyclic structure or a polycyclic (e.g., condensed ring or cross-linked ring) structure. Examples of the quaternary ammonium compounds include amidine compounds (including imidazole compounds).

The liquid component may include the base component in a free form or in the form of a cation or a salt. The base component in all of these forms may be referred to as the base component.

An equivalent ratio of the first carboxylic acid compound to the base component (=first carboxylic acid compound/base component) may be 0.4 or more and 10 or less, 0.4 or more and 8 or less, 0.4 or more and 5 or less, 0.4 or more and 4.0 or less, or 0.4 or more and 3.5 or less. In this case, high dissociation properties of the first carboxylic acid compound can be secured, and corrosion of electrodes can be suppressed. Also, it is easy to secure a high degree of withstand voltage properties. The lower limit of these ranges may be 0.6 or more, or 0.8 or more.

Note that an equivalent ratio of the base component to the first carboxylic acid compound means a ratio: (the total mole of OH⁻ that can be generated per molecule of the base component)/(the total number of carboxy groups per molecule of the first carboxylic acid compound).

An equivalent ratio of the base component to the acid component (=base component/acid component) may be 0.1 or more and 10 or less, 0.2 or more and 2 or less, or 0.3 or more and 1.5 or less. The equivalent ratio of the base component to the acid component may be selected from the ranges described above as the ranges of the equivalent ratio: (the first carboxylic acid compound)/(base component).

Note that the equivalent ratio of the base component to the acid component means a ratio: (the total mole of OH⁻ that can be generated per molecule of the base component)/(the total number of acid groups per molecule of the acid component).

### (Solvent)

Examples of the solvent included in the liquid component include non-aqueous solvents. Examples of the non-aqueous solvents include sulfone compounds, lactone compounds, carbonate compounds, and alcohol compounds. The liquid component may include one non-aqueous solvent or a combination of two or more non-aqueous solvents.

Out of aprotic polar solvents, examples of the sulfone compounds include cyclic sulfone compounds (e.g., sulfolane (SL)) and sulfoxide compounds (e.g., dimethyl sulfoxide and diethyl sulfoxide). Examples of the lactone compounds include γ-butyrolactone (GBL) and γ-valerolactone. Examples of the carbonate compounds include chain carbonates (e.g., dimethyl carbonate, diethyl carbonate, and ethyl methyl carbonate) and cyclic carbonates (e.g., ethylene carbonate, propylene carbonate, and fluoroethylene carbonate).

Out of the non-aqueous solvents, the alcohol compounds include monohydric alcohols and polyhydric alcohols. Examples of the polyhydric alcohols include glycol compounds (e.g., alkylene glycols (e.g., ethylene glycol (EG) and propylene glycol) and polyalkylene glycols (e.g., polyethylene glycol (PEG) and polypropylene glycol)), glycerin compounds (e.g., glycerin and polyglycerins), sugar alcohol compounds, and alkylene oxide adducts thereof (e.g., ethylene oxide adducts and polyethylene oxide adducts).

It is preferable that at least a glycol compound is included as a non-aqueous solvent from the viewpoint of improving the conductivity of the conductive polymer. The liquid component may include a glycol compound and a sulfone compound (e.g., a cyclic sulfone compound such as SL) as non-aqueous solvents, and additionally include a polyalkylene glycol (e.g., PEG) or the like.

### (Others)

The liquid component may include alkali metal ions (e.g., sodium ions, potassium ions, etc.). However, the lower the concentration of alkali metal ions in the liquid component is, the better. It is also preferable that the liquid component does not include alkali metal ions. This encompasses a case where the amount of alkali metal ions included in the liquid component is lower than or equal to the minimum detectable amount.

The concentration of alkali metal ions in the liquid component may be 100 ppm or less, or 50 ppm or less on the mass basis.

### (Capacitor Element)

The capacitor element included in the electrolytic capacitor includes an anode body having a dielectric layer on its surface and a conductive polymer that covers at least a portion of the dielectric layer. The conductive polymer constitutes at least a portion of a cathode body included in the capacitor element. The cathode body may further include a cathode extraction layer (e.g., a cathode foil).

### (Anode Body)

The anode body may include a valve metal, an alloy that includes a valve metal, a compound that includes a valve metal, and the like. One of these materials may be used alone, or two or more of them may be used in combination. For example, aluminum, tantalum, niobium, and titanium are preferably used as the valve metal.

An anode foil is preferably used as the anode body. It is preferable that the anode body includes a porous portion having pores at least as a surface layer of the anode body. Examples of anode bodies other than an anode foil include a sintered porous article or a molded porous article made of particles that include a valve metal.

An anode foil including a porous portion can be obtained by roughening a surface of a base material (e.g., a foil-shaped or plate-shaped base material) including a valve metal, for example. The surface may be roughened through etching (e.g., electrolytic etching or chemical etching), for example.

### (Dielectric Layer)

The dielectric layer is formed by causing anodic oxidation of the valve metal on the surface of the anode body. The anodic oxidation is caused by performing chemical conversion treatment, for example. The dielectric layer is formed in such a manner as to cover at least a portion of the surface of the anode body.

The dielectric layer includes a valve metal oxide. For example, when tantalum is used as the valve metal, the dielectric layer includes Ta₂O₅, and when aluminum is used as the valve metal, the dielectric layer includes Al₂O₃. Note that the dielectric layer is not limited to these examples, and is only required to function as a dielectric.

The dielectric layer is typically formed on the surface of the anode body. When the dielectric layer is formed on the surface of the porous portion of the anode body, the dielectric layer is formed along inner wall surfaces of the pores of the porous portion and dents (pits) in the surface of the anode body.

### (Conductive Polymer)

The conductive polymer includes a conjugated polymer and a dopant, for example. It is sufficient that the conductive polymer covers at least a portion of the dielectric layer. This includes a case where the conductive polymer is in contact with at least a portion of the dielectric layer. When the capacitor element includes an anode foil and a cathode foil, the conductive polymer may be interposed between these foils. In this case, a separator between the anode foil and the cathode foil may be impregnated with the conductive polymer. The conductive polymer may be in contact with at least a portion of the cathode foil, as well as being in contact with at least a portion of the dielectric layer. The conductive polymer may form a layer. The conductive polymer may also be called a solid electrolyte. The conductive polymer constitutes at least a portion of the cathode body included in the electrolytic capacitor. The conductive polymer may further include an additive as necessary.

### (Conjugated Polymer)

Examples of the conjugated polymer include known conjugated polymers used in electrolytic capacitors, such as π-conjugated polymers. Examples of the conjugated polymer include polymers whose basic skeletons are constituted of any of polypyrrole, polythiophene, polyaniline, polyfuran, polyacetylene, polyphenylene, polyphenylenevinylene, polyacene, and polythiophenevinylene. It is sufficient that the above-mentioned polymers include at least one type of monomer unit constituting the basic skeleton. The above-mentioned polymers also include homopolymers, copolymers of two or more monomers, and derivatives thereof (e.g., substitution products having a substituent). For example, polythiophene includes poly(3,4-ethylenedioxythiophene) (PEDOT).

One of the conjugated polymers may be used alone, or two or more of them may be used in combination.

The weight average molecular weight (Mw) of the conjugated polymer is not particularly limited, but is 1,000 or more and 1,000,000 or less, for example.

In this specification, the weight average molecular weight (Mw) is a value in terms of polysaccharide obtained through gel permeation chromatography (GPC) measurement. Note that the GPC measurement is generally performed using a polyhydroxymethacrylate gel column and an aqueous solution of sodium nitrate serving as a mobile phase.

### (Dopant)

Examples of the dopant include anions having a relatively low molecular weight and polymeric anions. Examples of the anions include a sulfate ion, a nitrate ion, a phosphate ion, a borate ion, organic sulfonate ions, and a carboxylate ion. Compounds that produce these anions are used as the dopant. Examples of dopants that produce a sulfonate ion include aromatic sulfonic acid compounds (e.g., p-toluenesulfonic acid and naphthalenesulfonic acid). The aromatic sulfonic acid compounds may have at least one selected from the group consisting of a carboxy group and a hydroxy group, for example.

Examples of the polymeric anions include polyvinylsulfonic acid, polystyrenesulfonic acid (PSS), polyallylsulfonic acid, polyacrylsulfonic acid, polymethacrylsulfonic acid, poly(2-acrylamide-2-methylpropanesulfonic acid), polyisoprenesulfonic acid, polyestersulfonic acid (e.g., aromatic polyestersulfonic acid), phenolsulfonate novolac resin, and polyacrylic acid. The polymeric anions may be a polymer of a single type of monomer, a copolymer of two or more types of monomers, or a substitution product having a substituent. In particular, polyanions derived from polystyrenesulfonic acid are preferable.

However, these dopants are merely examples, and there is no limitation to these examples. One of these dopants may be used alone, or two or more of them may be used in combination.

The conductive polymer may be formed by performing at least one of chemical polymerization and electrolytic polymerization of a precursor of the conjugated polymer on the dielectric layer in the presence of the dopant, for example. Alternatively, the conductive polymer (e.g., a layer of the conductive polymer) may be formed by bringing a solution in which the conductive polymer is dissolved or a dispersion in which the conductive polymer is dispersed into contact with the dielectric layer. The conductive polymer used in the solution or dispersion can be obtained by polymerizing a precursor of the conjugated polymer in the presence of the dopant. Examples of the precursor of the conjugated polymer include a material monomer of the conjugated polymer, an oligomer and a prepolymer in which a plurality of material monomer molecule chains are connected to each other. One precursor may be used alone, or two or more precursors may be used in combination.

There is no particular limitation on Mw of the dopant, and Mw of the dopant may be 1,000 or more and 1,000,000 or less, for example.

The amount of the dopant included in the conductive polymer is 10 parts by mass or more and 1000 parts by mass or less with respect to 100 parts by mass of the conjugated polymer, for example, and may be 20 parts by mass or more and 500 parts by mass or less.

### (Cathode Extraction Layer)

The cathode extraction layer includes a first layer that covers at least a portion of the conductive polymer, for example. The cathode extraction layer may include the first layer and a second layer that covers the first layer. Examples of the first layer include a layer that includes conductive particles and a metal foil (a cathode foil). The conductive particles are particles of, for example, at least one selected from the group consisting of conductive carbon and metal powder. For example, the cathode extraction layer may include a layer (also called a carbon layer) including conductive carbon (e.g., graphite) as the first layer and a layer including metal powder or a metal foil as the second layer. When a metal foil is used as the first layer, the cathode extraction layer may be constituted of the metal foil. The cathode extraction layer can be formed with use of a known method according to the layer configuration.

The layer including metal powder and serving as the second layer can be formed by applying a composition containing the metal powder onto the surface of the first layer, for example. Examples of such a second layer include a metal paste layer (e.g., a silver paste layer) formed of a composition containing metal powder such as silver particles and a resin (a binder resin), for example. It is possible to use a thermosetting resin such as an imide-based resin or an epoxy resin, or a thermoplastic resin as the resin.

When a metal foil is used as the first layer, there is no particular limitation on the metal, but it is preferable to use a valve metal such as aluminum, tantalum, or niobium, or an alloy containing a valve metal. The surface of the metal foil may be roughened as necessary. The surface of the metal foil may be provided with a chemical conversion film, a film of a metal (dissimilar metal) different from the metal constituting the metal foil, or a film of a non-metal material. Examples of the dissimilar metal and the non-metal material include metals such as titanium and non-metal materials such as carbon (e.g., conductive carbon).

It is also possible to use the above-described film of a dissimilar metal or a non-metal material (e.g., conductive carbon) as the first layer, and use the above-described metal foil as the second layer.

### (Separator)

A separator may be placed between the cathode body (e.g., a cathode foil) and the anode body (e.g., an anode foil). The separator is not particularly limited, and for example, a nonwoven fabric containing fibers of cellulose, polyethylene terephthalate, vinylon, or polyamide (e.g., aliphatic polyamide or aromatic polyamide such as aramid) may be used as the separator.

When the capacitor element includes the separator, the separator may be impregnated with the conductive polymer. The conductive polymer may be interposed between the anode body (e.g., an anode foil) and the cathode body (e.g., a cathode foil) and in contact with at least a portion of the dielectric layer and at least a portion of the cathode body. According to the present disclosure, a high conductivity of the conductive polymer can be maintained due to the combination of the conductive polymer and the liquid component including the first carboxylic acid compound, and accordingly, it is possible to suppress a reduction in the ESR even in these configurations.

### (Others)

The electrolytic capacitor may be of a wound type, a chip type, or a laminated type. The electrolytic capacitor includes at least one capacitor element. The electrolytic capacitor may include a plurality of capacitor elements. For example, the electrolytic capacitor may include a laminated body including two or more capacitor elements or include two or more wound capacitor elements. The configuration or the number of capacitor elements can be selected according to the type of the electrolytic capacitor or an intended use thereof.

An end portion of a cathode lead is electrically connected to the cathode extraction layer of the capacitor element. An end portion of an anode lead is electrically connected to the anode body. The other end portions of the anode lead and the cathode lead are pulled out from an exterior body or a case. The other end portions of the leads exposed from the exterior body or the case are used for soldering to a substrate on which the electrolytic capacitor is to be mounted, for example. It is possible to use lead wires or lead frames as the leads.

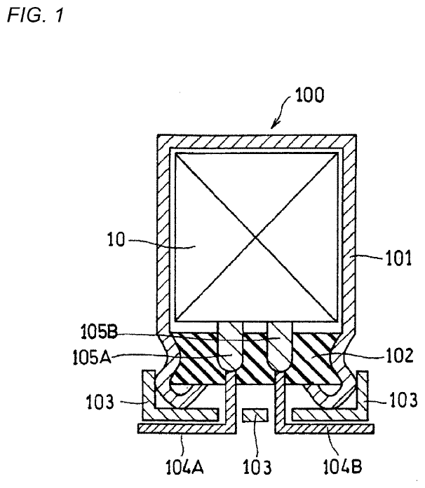

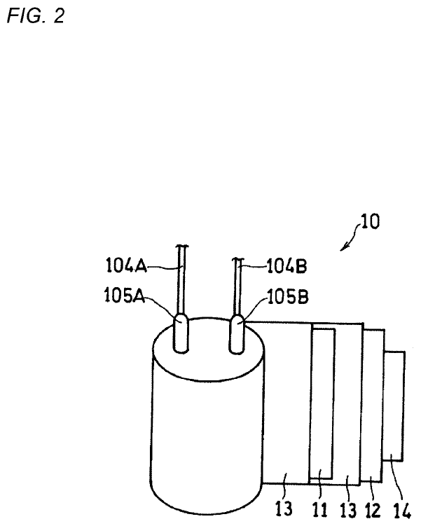

FIG. 1 is a schematic cross-sectional view of an electrolytic capacitor according to the present embodiment, and FIG. 2 is a schematic diagram showing a capacitor element of the electrolytic capacitor with a portion thereof being developed. However, the electrolytic capacitor according to the present disclosure is not limited to the embodiment described below. Also, constituent elements in the following embodiment may be combined with at least one of (1) to (13) described above for the solid electrolytic capacitor according to the present disclosure, or may be combined with at least one of (1) to (13) described above and the constituent elements described above.

The electrolytic capacitor includes, for example, a capacitor element 10, a bottomed case 101 that houses the capacitor element 10 and the liquid component (not illustrated), a sealing member 102 that closes the opening of the bottomed case 101, a seat plate 103 that covers the sealing member 102, lead wires 104A and 104B that are led out from the sealing member 102 and penetrate the seat plate 103, and lead tabs 105A and 105B that connect the lead wires to the electrodes of the capacitor element 10. The region around the open end of the bottomed case 101 is drawn inward, and the open end is curled so as to be swaged on the sealing member 102.

The capacitor element 10 is a wound body as shown in FIG. 2, for example. The wound body includes an anode foil 11 connected to the lead tab 105A, a cathode foil 12 connected to the lead tab 105B, and a separator 13. The anode foil 11 and the cathode foil 12 are wound with the separator 13 being disposed therebetween. The outermost circumference of the wound body is fixed using fixation tape 14. Note that FIG. 2 shows the wound body, with a portion thereof being developed, before the outermost circumference of the wound body is fixed.

In the capacitor element 10, a dielectric layer (not shown) is formed on the surface of at least a portion of the anode foil 11. The separator 13 and a conductive polymer (not shown) are interposed between the anode foil 11 and the cathode foil 12. The conductive polymer is in contact with at least a portion of the dielectric layer. Also, the conductive polymer is in contact with at least a portion of the cathode foil 12. The conductive polymer and the separator are impregnated with the liquid component.

### EXAMPLES

The following specifically describes the electrolytic capacitor according to the present disclosure based on examples and comparative examples, but the electrolytic capacitor according to the present disclosure is not limited to the following examples.

### Production Example 1

A first carboxylic acid compound a1 was produced as follows.

In a nitrogen atmosphere, sodium hydride (48 mmol) was added to a suspension in which ethylene glycol (24 mmol) was suspended in xylene (100 g), and the suspension was stirred. An n-octylsuccinic acid anhydride (48 mmol) was dripped into the resulting mixture to carry out a reaction for 5 hours. After the reaction, a sulfuric acid aqueous solution (5% by mass concentration, 100 g) was added to the resulting mixture, and the mixture was transferred to a liquid separation funnel and shaken well to separate a water phase and an organic phase. The water phase was removed, and the organic phase was washed with pure water. The solvent was removed from the washed organic phase with use of an evaporator. The structure of the obtained first carboxylic acid compound a1 was confirmed through analysis by performing liquid chromatography mass spectrometry (LC/MS) (ion source: ESI⁻).

### Production Example 2

A first carboxylic acid compound a2 was produced in the same manner as in the production example 1, except that tripropylene glycol (24 mmol) was used instead of ethylene glycol.

### Production Example 3

A first carboxylic acid compound a3 was produced in the same manner as in the production example 1, except that ethylene diamine (24 mmol) was used instead of ethylene glycol and triethylamine (48 mmol) was used instead of sodium hydride.

### Production Example 4

A first carboxylic acid compound a4 was produced in the same manner as in the production example 1, except that a 1,2-cyclohexane dicarboxylic acid anhydride (48 mmol) was used instead of the n-octylsuccinic acid anhydride.

### Production Example 5

A first carboxylic acid compound a5 was produced in the same manner as in the production example 1, except that a 2-octenylsuccinic acid anhydride (48 mmol) was used instead of the n-octylsuccinic acid anhydride.

### Production Example 6

A first carboxylic acid compound a6 was produced in the same manner as in the production example 1, except that an n-butylsuccinic acid anhydride (48 mmol) was used instead of the n-octylsuccinic acid anhydride.

### Production Example 7

A first carboxylic acid compound a7 was produced in the same manner as in the production example 1, except that an n-dodecylsuccinic acid anhydride (48 mmol) was used instead of the n-octylsuccinic acid anhydride.

### Production Example 8

A first carboxylic acid compound a8 was produced in the same manner as in the production example 1, except that an n-dodecenylsuccinic acid anhydride (48 mmol) was used instead of the n-octylsuccinic acid anhydride.

### Production Example 9

A first carboxylic acid compound a9 was produced in the same manner as in the production example 1, except that a 2,2-dimethylsuccinic acid anhydride (48 mmol) was used instead of the n-octylsuccinic acid anhydride.

### Production Example 10

A first carboxylic acid compound a10 was produced in the same manner as in the production example 1, except that a phenylsuccinic acid anhydride (48 mmol) was used instead of the n-octylsuccinic acid anhydride.

### Production Example 11

A first carboxylic acid compound all was produced in the same manner as in the production example 5, except that 1,4-butanediol (24 mmol) was used instead of ethylene glycol.

### Production Example 12

A first carboxylic acid compound a12 was produced in the same manner as in the production example 5, except that 1,9-nonanediol (24 mmol) was used instead of ethylene glycol.

### Production Example 13

A first carboxylic acid compound a13 was produced in the same manner as in the production example 5, except that triethylene glycol (24 mmol) was used instead of ethylene glycol.

### Production Example 14

A first carboxylic acid compound a14 was produced in the same manner as in the production example 5, except that 2-butyl-2-ethyl-1,3-propanediol (24 mmol) was used instead of ethylene glycol.

### Production Example 15

Trimethylolpropane (24 mmol) was used instead of ethylene glycol, and the 2-octenylsuccinic acid anhydride was used in an amount of 72 mmol. A first carboxylic acid compound a15 was produced in the same manner as in the production example 5, except for these changes.

### Production Example 16

A first carboxylic acid compound a16 was produced in the same manner as in the production example 5, except that piperazine (24 mmol) was used instead of ethylene glycol, and triethylamine (48 mmol) was used instead of sodium hydride.

### Production Example 17

A first carboxylic acid compound a17 was produced in the same manner as in the production example 5, except that N,N′-diisopropylethylenediamine (24 mmol) was used instead of ethylene glycol, and triethylamine (48 mmol) was used instead of sodium hydride.

### Production Example 18

A first carboxylic acid compound a18 was produced in the same manner as in the production example 1, except that 5-norbornene-2,3-dicarboxylic acid (48 mmol) was used instead of the n-octylsuccinic acid anhydride.

### Production Example 19

A first carboxylic acid compound a19 was produced in the same manner as in the production example 1, except that phthalic acid (48 mmol) was used instead of the n-octylsuccinic acid anhydride.

### Examples 1 to 28 and Comparative Examples 1 to 11

Wound electrolytic capacitors (rated voltage: 25 V, rated capacitance: 330 μF) were produced and evaluated as follows.

### (Preparation of Anode Body)

An aluminum foil with a thickness of 100 μm was etched and thus the surface of the aluminum foil was roughened. Thereafter, a dielectric layer was formed on the surface of the aluminum foil through chemical conversion treatment. The chemical conversion treatment was performed by immersing the aluminum foil in an ammonium adipate solution and applying a voltage thereon. Then, the aluminum foil was cut to have a length of 8 mm and a width of 120 mm to prepare an anode body.

### (Preparation of Cathode Body)

An aluminum foil with a thickness of 50 μm was etched and thus the surface of the aluminum foil was roughened. Then, the aluminum foil was cut to have a length of 8 mm and a width of 120 mm to prepare a cathode body.

### (Production of Wound Body)

An anode lead tab and a cathode lead tab were connected to the anode body and the cathode body, respectively, and the anode body and the cathode body were wound with a separator being disposed therebetween while catching the lead tabs. An anode lead wire and a cathode lead wire were connected to the ends of the lead tabs protruding from the wound body. The chemical conversion treatment was performed on the produced wound body again to form a dielectric layer on the cut end portion of the anode body. Next, an end portion of the outer surface of the wound body was fixed using fixation tape to complete the wound body.

### (Preparation of Polymer Dispersion Containing Conductive Polymer)

A mixed solution was prepared by dissolving 3,4-ethylene dioxythiophene and poly(4-styrenesulfonic acid) (PSS, with Mw of 100,000) used as a polymeric dopant in ion-exchanged water. Oxidizing agents (iron(III) sulfate and ammonium persulfate) dissolved in ion-exchanged water were added to the mixed solution while the mixed solution was stirred to carry out a polymerization reaction. After the reaction, the resulting reaction solution was dialyzed to remove the unreacted monomer and the excessive oxidizing agents, and thus a polymer dispersion that contained poly(3,4-ethylene dioxythiophene) doped with PSS (PEDOT/PSS) as a conductive polymer was obtained. Note that the Mw of the polymeric dopant is a value measured under the conditions described above.

(Covering of Dielectric Layer with Conductive Polymer)

The wound body was immersed in the polymer dispersion contained in a predetermined container for 5 minutes in a reduced pressure atmosphere (40 kPa), and then the wound body was taken out from the polymer dispersion. Next, the wound body impregnated with the polymer dispersion was dried in a drying furnace at 150° C. for 20 minutes to cover at least a portion of the dielectric layer with the conductive polymer. Thus, a capacitor element was formed. Note that capacitor elements in Comparative Examples 8 to 10 were formed without carrying out this step for covering the dielectric layer with the conductive polymer.

(Impregnation with Liquid Component)

A mixture obtained by mixing EG, PEG (number average molecular weight Mn: 300), and SL at a volume ratio: EG:PEG:SL=1:1:1 was used as a solvent of the liquid component. The liquid component was prepared by dissolving solutes in the mixture. Acid components shown in Tables 1 and 2 and base components such as triethylamine (TEA) shown in Table 2 were used as the solutes. In Examples and Comparative Examples 8 and 9, the first carboxylic acid compounds produced in the production examples 1 to 19 were used. Table 1 also shows the number of first moieties included in each first carboxylic acid compound. The amounts of components added to the solvent were adjusted such that the concentrations of acid components and base components in the liquid component were as shown in Table 2. Table 2 also shows equivalent ratios of the acid components to the base components.

### (Assembly of Electrolytic Capacitor)

The capacitor element was impregnated with the liquid component by leaving the capacitor element immersed in the liquid component for 5 minutes in a reduced pressure atmosphere (40 kPa).

The capacitor element impregnated with the liquid component was housed in a bottomed case such that the lead wires were located on the opening side of the bottomed case. A sealing member (elastic material containing butyl rubber as a rubber component) formed such that the lead wires penetrate therethrough was placed above the capacitor element. Then, the region near the open end of the bottomed case was drawn, and the open end was curled to come into intimate contact with the sealing member. Thus, the capacitor element and the liquid component were sealed in the bottomed case. A seat plate was placed on the curled portion, and thus an electrolytic capacitor like that shown in FIG. 1 was completed. A total of 40 electrolytic capacitors were produced in each example. The produced electrolytic capacitors were aged at 130° C. for 2 hours while the rated voltage was applied thereto.

### [Evaluation]

The following evaluation was performed on the electrolytic capacitors produced as described above.

(1) Capacitance change (Δcap) and ESR change (ΔESR)

As for each of 20 electrolytic capacitors subjected to the aging, a capacitance at a frequency of 120 Hz and an ESR value at a frequency of 100 kHz were measured in an environment at 20° C. with use of an LCR meter, and average values (initial capacitance: X0 (F), initial ESR value: Y0 (Ω)) were calculated.

After X0 and Y0 were measured, a high-temperature load test (accelerated test) was performed. That is to say, the rated voltage was applied to the electrolytic capacitors for 1000 hours at a temperature of 145° C. An average capacitance (X1 (F)) and an average ESR value (Y1 (Ω)) of the electrolytic capacitors subjected to the accelerated test were measured in the same manner as the measurement of the initial capacitance and the initial ESR value.

An initial capacitance change (Δcap) and an ESR change (ΔESR) were calculated from X0, X1, Y0, and Y1 with use of the following formulas.

$$Δ cap = X 1 / X 0$$

$$Δ ESR = Y 1 / Y 0$$

### (2) Change in Leakage Current (ΔLC)

As for each of the remaining 20 electrolytic capacitors subjected to the aging, a resistor with a resistance of 1 kΩ was connected in series, and a leakage current was measured after the rated voltage of 25 V was applied for 1 minute with use of a DC power source, and an average value (Z0: initial leakage current (A)) was calculated.

An accelerated test was performed at a temperature of 145° C. without applying a voltage on the 20 electrolytic capacitors for which the initial leakage current Z0 was measured. A leakage current (A) of each electrolytic capacitor subjected to the accelerated test was measured in the same manner as in the measurement of the initial leakage current, and an average value (Z1: leakage current (A) after the accelerated test) of the 20 electrolytic capacitors was calculated.

$$Δ LC = Z 1 / Z 0$$

Table 1 shows the acid components used in the liquid component. Table 2 shows evaluation results of the electrolytic capacitors. In Table 1, a1 to a19 represent the first carboxylic acid compounds, and b1 to b3 represent acid components (specifically, second carboxylic acid compounds) other than the first carboxylic acid compounds. In Table 2, A1 to A28 are Examples, and B1 to B11 are Comparative Examples.

TABLE 1

| | Acid component | | | | |
|---|---|---|---|---|---|
| | | First linking group | | | |
| | | | First substituent | | |
| | | | at α position of | | Number |
| | | Main | first carboxy | | of first |
| | Type | chain | group | Second linking group | moieties |
| a1 | First | Ethylene | —C₈H₁₇ | —OCH₂CH₂O— | 2 |
| a2 | carboxylic | chain | (n-octyl group) | —O—[CH₂CH(CH₃)O]₃— | |
| a3 | acid | | | —NHCH₂CH₂NH— | |
| a5 | compound | | —C₈H₁₅ | —OCH₂CH₂O— | |
| | | | (2-octenyl | | |
| | | | group) | | |
| a6 | | | n-butyl group | | |
| a7 | | | n-dodecyl group | | |
| a8 | | | 2-dodecenyl | | |
| | | | group | | |
| a9 | | | Methyl group, | | |
| | | | methyl group | | |
| a10 | | | Phenyl group | | |
| a11 | | | —C₈H₁₅ | —O(CH₂)₄O— | |
| a12 | | | (2-octenyl | —O(CH₂)₉O— | |
| a13 | | | group) | —O(CH₂CH₂O)₃— | |
| a14 | | | | —OCH₂C(CH₂CH₃)(n- | |
| | | | | C₄H₉)CH₂O— | |
| a15 | | | | CH₃CH₂C(CH₂O—)₃ | 3 |
| a16 | | | | Piperazine-1,4-diyl | 2 |
| a17 | | | | —N(i-Pr)CH₂CH₂N(i-Pr)— | |
| a4 | | 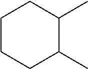 | (Cyclohexane- 1,2-diyl group) | —OCH₂CH₂O— | |
| a18 | | 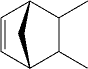 | (5-norbornene- 2,3-diyl group) | | |
| a19 | | 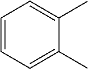 | (1,2-phenylene group) | | |

| | | |
|---|---|---|
| b1 | Second | Phthalic acid |
| | carboxylic | |
| b2 | acid | Adipic acid |
| b3 | compound | Octane-1,7-dicarboxylic acid |

※i-Pr: isopropyl

TABLE 2

| | | Liquid component | | | | | | | |
|---|---|---|---|---|---|---|---|---|---|
| | | | | | | Acid | | | |
| | | | | Concentration | Concentration | component/base | | | |
| | | | | of acid | of base | component | | | |
| | Conductive | Acid | Base | component | component | (equivalent | | | |
| | polymer | component | component | (mass %) | (mass %) | ratio) | Δcap | ΔESR | ΔLC |
| A1 | Included | a1 | TEA | 10.8 | 1.2 | 3.8 | 0.87 | 2.25 | 1.55 |
| A2 | Included | a1 | TEA | 10.8 | 1.4 | 3.3 | 0.88 | 2.07 | 0.73 |
| A3 | Included | a2 | TEA | 11.0 | 1.1 | 3.2 | 0.89 | 1.88 | 1.14 |
| A4 | Included | a2 | TEA | 11.0 | 1.1 | 3.2 | 0.88 | 1.96 | 0.79 |
| A5 | Included | a3 | TEA | 2.7 | 1.3 | 0.8 | 0.88 | 1.68 | 1.05 |
| A6 | Included | a4 | TEA | 11.1 | 0.9 | 7.1 | 0.88 | 1.95 | 0.98 |
| A7 | Included | a5 | TEA | 11.3 | 1.4 | 3.4 | 0.92 | 1.31 | 0.99 |
| A8 | Included | a5 | TBA | 10.9 | 2.2 | 3.8 | 0.92 | 1.24 | 0.76 |
| A9 | Included | a5 | DMOA | 11.0 | 2.0 | 3.7 | 0.93 | 1.24 | 0.86 |
| A10 | Included | a5 | Pyr | 11.4 | 1.1 | 3.3 | 0.86 | 1.33 | 0.76 |
| A11 | Included | a5 | Imd | 11.5 | 1.0 | 3.3 | 0.90 | 1.42 | 1.04 |
| A12 | Included | a5 | DBU | 11.0 | 1.9 | 3.6 | 0.90 | 1.36 | 0.83 |
| A13 | Included | a6 | TEA | 13.9 | 2.1 | 3.5 | 0.88 | 1.73 | 1.78 |
| A14 | Included | a7 | TEA | 11.4 | 1.2 | 3.3 | 0.90 | 1.32 | 2.56 |
| A15 | Included | a8 | TEA | 11.4 | 1.2 | 3.3 | 0.90 | 1.33 | 1.28 |
| A16 | Included | a9 | TEA | 11.0 | 2.1 | 3.7 | 0.89 | 1.54 | 1.16 |
| A17 | Included | a10 | TEA | 11.2 | 1.6 | 3.5 | 0.90 | 1.32 | 1.19 |
| A18 | Included | a11 | TEA | 11.3 | 1.3 | 3.4 | 0.91 | 1.33 | 1.24 |
| A19 | Included | a12 | TEA | 11.4 | 1.2 | 3.3 | 0.91 | 1.27 | 1.03 |
| A20 | Included | a13 | TEA | 11.4 | 1.2 | 3.4 | 0.91 | 1.26 | 2.00 |
| A21 | Included | a13 | TEA | 22.9 | 2.1 | 3.9 | 0.88 | 1.84 | 0.85 |
| A22 | Included | a14 | TEA | 11.3 | 1.4 | 3.4 | 0.91 | 1.38 | 1.10 |
| A23 | Included | a15 | TEA | 11.5 | 0.9 | 4.9 | 0.89 | 1.28 | 1.86 |
| A24 | Included | a16 | TEA | 3.3 | 1.3 | 1.0 | 0.90 | 1.69 | 2.28 |
| A25 | Included | a17 | TEA | 3.4 | 1.2 | 1.0 | 0.90 | 1.36 | 0.72 |
| A26 | Included | a18 | TEA | 11.2 | 1.6 | 3.5 | 0.90 | 1.49 | 1.18 |
| A27 | Included | a19 | TEA | 11.1 | 1.8 | 3.6 | 0.91 | 1.31 | 0.96 |
| A28 | Included | a5 + b3 | TEA | 3.5 + 8.3 | 1.4 | 1.2 | 0.89 | 1.45 | 0.84 |
| B1 | Included | b1 | TEA | 19.5 | 4.5 | 5.2 | 0.82 | 3.10 | 1.08 |
| B2 | Included | b2 | TEA | 9.7 | 2.3 | 5.8 | 0.65 | 172.09 | 1.03 |
| B3 | Included | b2 | TEA | 4.8 | 1.2 | 5.8 | 0.78 | 13.29 | 2.86 |
| B4 | Included | b2 | TEA | 5.1 | 1.1 | 6.4 | 0.82 | 9.34 | 2.30 |
| B5 | Included | b3 | TEA | 10.1 | 1.9 | 4.8 | 0.79 | 145.37 | 1.15 |
| B6 | Included | b3 | TEA | 5.1 | 0.9 | 4.8 | 0.82 | 9.95 | 2.85 |
| B8 | Not included | a1 | TEA | 10.5 | 1.5 | 4.1 | 0.43 | 8.22 | 0.55 |
| B9 | Not included | a2 | TEA | 10.9 | 1.3 | 3.1 | 0.45 | 6.45 | 0.79 |
| B10 | Not included | b1 | TEA | 10.5 | 1.5 | 8.4 | 0.53 | 5.02 | 0.67 |
| B11 | Not included | b3 | TEA | 10.1 | 1.9 | 4.8 | 0.41 | 9.56 | 0.66 |

TEA: triethylamine
TBA: tributylamine
DMOA: dimethyloctylamine
Pyr: pyridine
Imd: imidazole
DBU: diazabicycloundecene

As shown in Table 2, as for the electrolytic capacitors (B8 to B11) that did not include a conductive polymer, the leakage current after the accelerated test was suppressed to be small, but the capacitance decreased significantly. Also, there is no large difference in ΔESR between the cases where liquid components including first carboxylic acid compounds were used and the cases where liquid components including acid components other than the first carboxylic acid compounds were used.

On the other hand, as for the electrolytic capacitors including a conductive polymer, there is a large difference particularly in ΔESR between the cases where liquid components including first carboxylic acid compounds were used and the cases where liquid components including acid components (second carboxylic acid compounds) other than the first carboxylic acid compounds were used. More specifically, ΔESR is 3.10 to 172.09 in B1 to B6 in which liquid components including second carboxylic acid compounds were used. In particular, ΔESR is as large as 9.34 to 172.09 in B2 to B6 in which aliphatic dicarboxylic acids were used. In contrast, in A1 to A28 in which liquid components including first carboxylic acid compounds were used in the electrolytic capacitors including a conductive polymer, ΔESR is 2.25 or less, which is significantly smaller than ΔESR of B1 to B6, and a change in the ESR due to the accelerated test was suppressed to be small. As for each of the first carboxylic acid compounds used in A1 to A5 and A7 to A25, the main chain of the compound as a whole can be said to be an aliphatic chain, but ΔESR was noticeably suppressed in these examples compared with B2 to B6 in which aliphatic dicarboxylic acids were used. As described above, it can be said that the behavior of ΔESR affected by the liquid components including first carboxylic acid compounds significantly differs between the cases where the electrolytic capacitors included a conductive polymer and the cases where the electrolytic capacitors did not include a conductive polymer. Moreover, the leakage current after the accelerated test was relatively small in A1 to A28, and capacitances larger than those in B1 to B6 were obtained in A1 to A28 even after the accelerated test. As described above, the electrolytic capacitors of Examples maintained excellent capacitor performance even after the accelerated test and have excellent reliability.

Although the present invention has been described in terms of the presently preferred embodiments, such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications that fall within the true spirit and scope of the invention.

### INDUSTRIAL APPLICABILITY

The electrolytic capacitor according to the present disclosure can be used as a hybrid electrolytic capacitor. It is possible to suppress a change in the ESR of the electrolytic capacitor over time. Also, it is possible to suppress an increase in a leakage current over time and secure a high degree of withstand voltage properties of the electrolytic capacitor. Accordingly, the electrolytic capacitor according to the present disclosure is suitable particularly for various applications in which high reliability or a long service life is required. However, applications of the electrolytic capacitor are not limited to those applications.

### REFERENCE SIGNS LIST

100: electrolytic capacitor, 101: bottomed case, 102: sealing member, 103: seat plate, 104A, 104B: lead wire, 105A, 105B: lead tab, 10: capacitor element, 11: anode foil, 12: cathode foil, 13: separator, 14: fixation tape

1. An electrolytic capacitor comprising:
a capacitor element; and
a liquid component,
wherein the capacitor element includes an anode body having a dielectric layer on a surface thereof and a conductive polymer covering at least a portion of the dielectric layer,
the liquid component includes an acid component and a solvent,
the acid component includes a first carboxylic acid compound that has a plurality of first moieties, and
the plurality of first moieties each independently have:
a first carboxy group including a first carbonyl group;
a second carbonyl group; and
a first linking group linking the first carbonyl group and the second carbonyl group.

2. The electrolytic capacitor according to claim 1,
wherein the first carboxylic acid compound includes a second linking group, and
the second linking group links the second carbonyl groups of the plurality of first moieties.

3. The electrolytic capacitor according to claim 2,
wherein the second linking group has an oxygen atom or an amino group linked to each of the second carbonyl groups.

4. The electrolytic capacitor according to claim 1,
wherein the first linking groups of at least two of the first moieties have the same structure.

5. The electrolytic capacitor according to claim 1,
wherein, in the first linking groups of at least two of the first moieties, a main chain linking a first carbon atom in the first carbonyl group and a second carbon atom in the second carbonyl group has 1 to 4 carbon atoms.

6. The electrolytic capacitor according to claim 1,
wherein the first linking groups of at least two of the first moieties each include a non-aromatic cyclic divalent group or an aromatic divalent group.

7. The electrolytic capacitor according to claim 1,
wherein, in the first linking groups of at least two of the first moieties, a main chain linking a first carbon atom in the first carbonyl group and a second carbon atom in the second carbonyl group is an aliphatic divalent group.

8. The electrolytic capacitor according to claim 7,
wherein the aliphatic divalent group has one or more first substituents, and
the aliphatic divalent group has a monovalent aliphatic hydrocarbon group having 6 or more carbon atoms as at least one of the one or more first substituents.

9. The electrolytic capacitor according to claim 8,
wherein the aliphatic divalent group has the monovalent aliphatic hydrocarbon group at an α position of the first carbonyl group.

10. The electrolytic capacitor according to claim 1,
wherein the acid component further includes a second carboxylic acid compound that differs from the first carboxylic acid compound.

11. The electrolytic capacitor according to claim 1,
wherein the first carboxylic acid compound accounts for 20% by mass or more of the acid component.

12. The electrolytic capacitor according to claim 1,
wherein the liquid component further includes a base component.

13. The electrolytic capacitor according to claim 12,
wherein an equivalent ratio of the first carboxylic acid compound to the base component is 0.4 or more and 10 or less.
